(19) United States
(12) Patent Application Publication
(10) Pub. No.: US 2005/0145082 A1
(43) Pub. Date: Jul. 7, 2005

(54) [COMPOUND MITER GUIDE FOR HAND SAW]

(75) Inventor: Richard J. Moe, Waterloo, Ontario (CA)

Correspondence Address: JOHN J. ELNITSKI, JR., 225 A SNOWBIRD LANE, BELLEFONTE, PA, 16823, US

(73) Assignees: Richard J. Moe, Waterloo, Ontario (CA); Donald R.J. Montpetit, Chestermere, Alberta (CA)

(21) Appl. No.: 10/707,691

(22) Filed: Jan. 5, 2004

(51) Int. Cl. B23D 19/00; B27B 11/02

(52) U.S. Cl. 83/468.3; 83/486.1; 83/581; 83/763

(57) ABSTRACT

A compound miter guide having a base plate, fence base plate fastener, blade guide, at least one side rail, and at least one protractor. The fence is pivotally attached to the bottom of the base plate. The base plate fastener is used to movably connect the fence to the base plate along the curved slot. The blade guide is pivotally attached to the base plate at the cutting side of the base plate using a pivotal connection. The at least one side rail has a top and bottom and being attached between the base plate and the blade guide. The at least one protractor is inscribed between the top and the bottom on one of the at least one side rail.

### BACKGROUND OF INVENTION

The present invention generally relates to miter guides for a hand saw. More specifically, the present invention relates to an adjustable compound miter guide for use with a hand saw.

There has always been a need to cut materials at a precise uniform angle. Especially, wooden materials, such as wooden boards. There are two types of aids that have been developed to allow a precise uniform angle cut of materials. The first is a miter box and the second is a miter guide. The standard miter box includes two sides with at least one set of paired angle slots cut in the sides. Whereby, one of the paired angle slots is in one side of the miter box, while the other of the paired angle slots is in the other side of the miter box. The paired angled slots are aligned to receive a saw, which is placed above the material to be cut. The paired angled slots act as a guide to hold the saw at the correct angle during cutting of the material. The paired angled slots are usually fixed and can not be adjusted. The miter guide rests on the material to be cut and includes a slotted saw guide. The slotted saw guide is adjustable to almost any angle and is an improvement over the miter box. Problems with current miter guides are that the slotted saw guide is cumbersome to set at the correct angle, the miter guides are hard to hold due to positioning of components which contact the material to be cut, and the miter guides can only accommodate one type of saw.

It is an object of the present invention to provide a compound miter guide for a hand saw which is simple to set up and use.

It is another object of the present invention to provide a compound miter guide for a hand saw which allows the use of different types of saws.

### SUMMARY OF INVENTION

A compound miter guide having a base plate, fence, base plate fastener, blade guide, at least one side rail, and at least one protractor. The fence is pivotally attached to the bottom of the base plate. The base plate fastener is used to movably connect the fence to the base plate along the curved slot. The blade guide is pivotally attached to the base plate at the cutting side of the base plate using a pivotal connection. The at least one side rail has a top and bottom and being attached between the base plate and the blade guide. There is at least one protractor inscribed between the top and the bottom on one of the at least one side rail.

### BRIEF DESCRIPTION OF DRAWINGS

FIG. 1 is a side view of a compound miter guide according to the present invention.

FIG. 2 is a rear view of the compound miter guide of FIG. 1 according to the present invention.

FIG. 3 is a top view of the compound miter guide of FIG. 1 according to the present invention.

FIG. 4 is a side view of a compound miter guide according to the present invention.

FIG. 5 is a top view of the compound miter guide of FIG. 4 according to the present invention.

FIG. 6 is a side view of a compound miter guide according to the present invention.

FIG. 7 is a side view of blade guides according to the present invention.

FIG. 8 is a perspective view of a compound miter guide according to the present invention.

FIG. 9 is a perspective view of a compound miter guide according to the present invention.

FIG. 10 is a perspective exploded view of a compound miter guide of FIG. 9 according to the present invention.

FIG. 11 is a top exploded view of a compound miter guide of FIG. 9 according to the present invention.

FIG. 12 is a side view of a blade guide according to the present invention.

FIG. 13 is a side view of a sliding blade guide according to the present invention.

FIG. 14 is a side view of a sliding blade guide according to the present invention.

### DETAILED DESCRIPTION

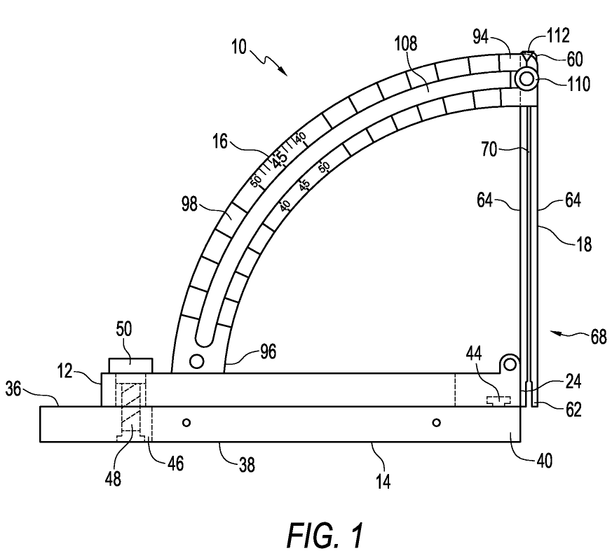

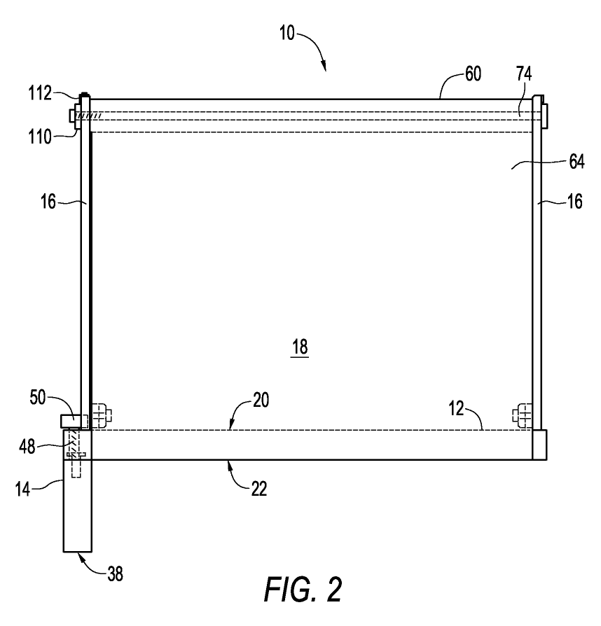

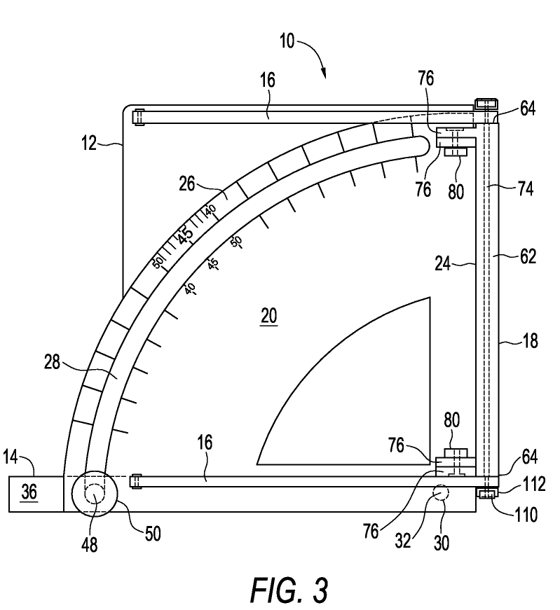

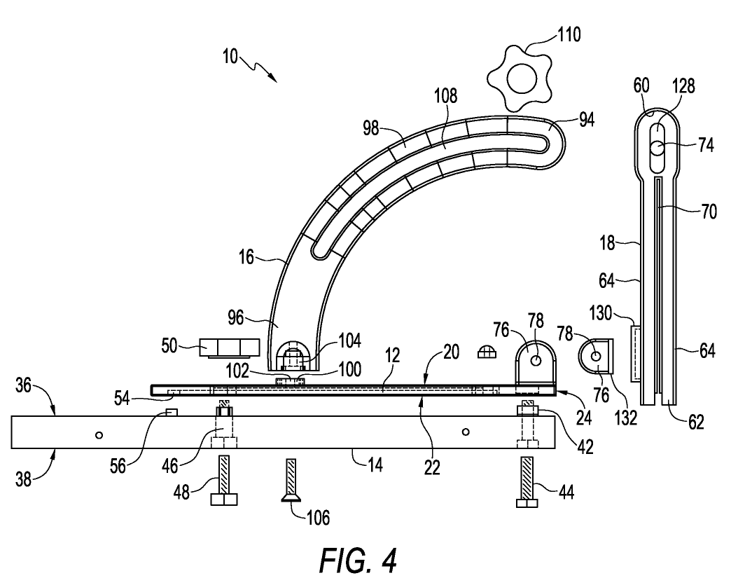

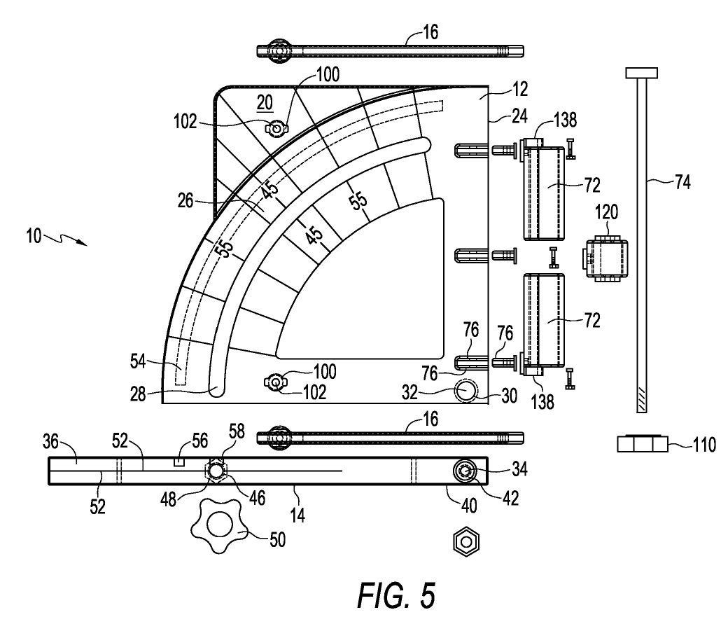

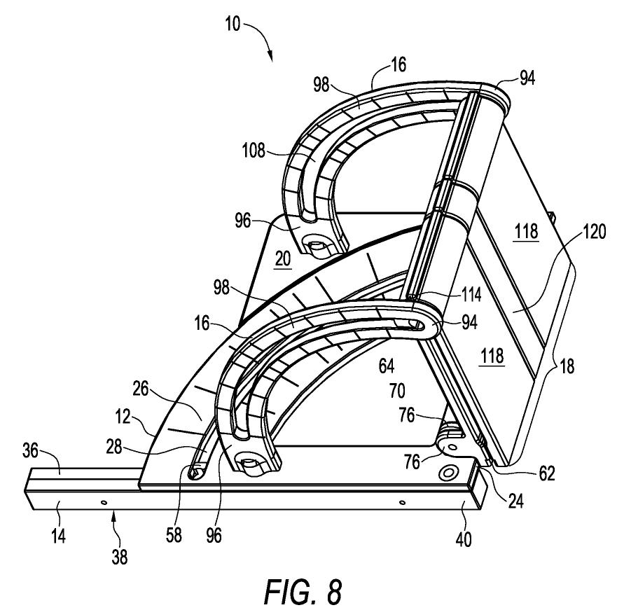

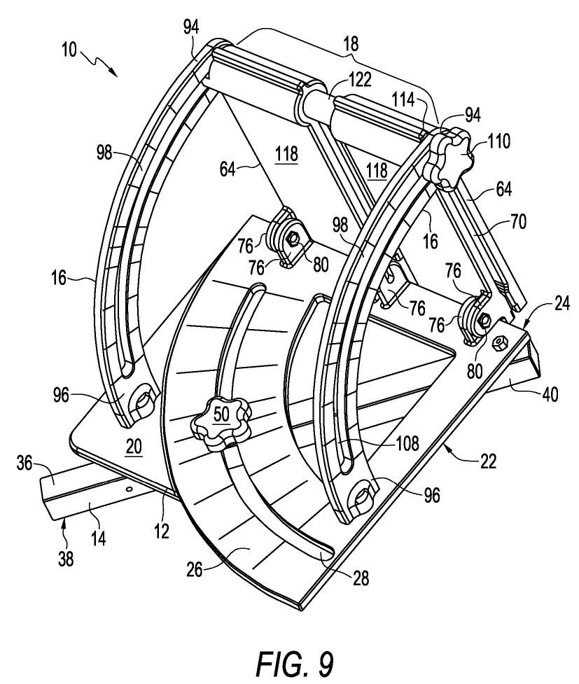

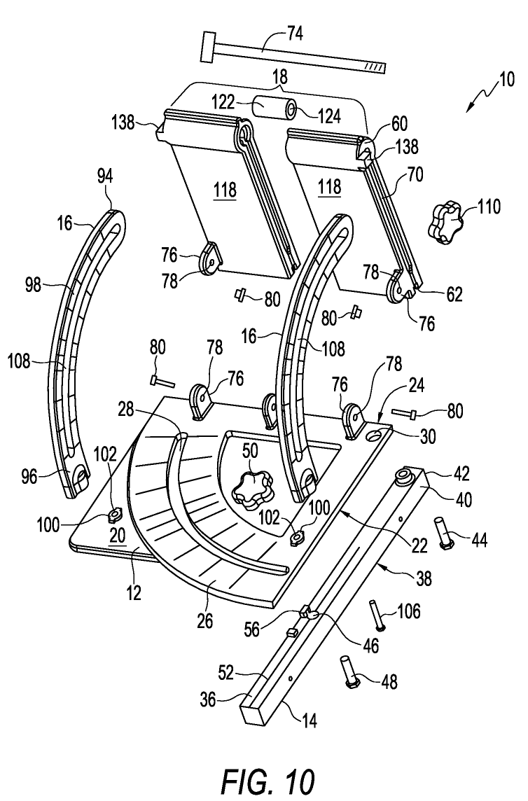

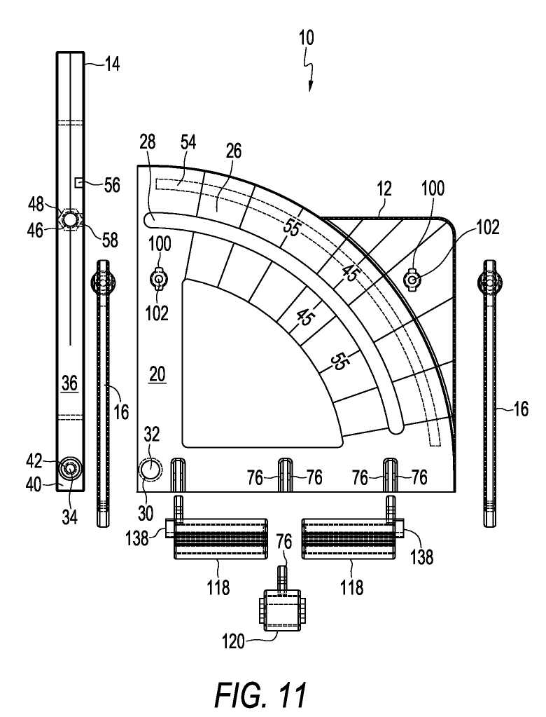

The present invention is a compound miter guide 10 for use with a hand saw. Different embodiments are shown in FIGS. 1-14. Common to all embodiments is a base plate 12, fence 14, at least one side rail 16 and a blade guide 18. The base plate 12 includes a top 20 and a bottom 22. The base plate 12 includes a cutting side 24. The base plate 12 includes a protractor 26 indicating degrees of angle inscribed on the top 20 of the base plate 12. The base plate 12 includes an open curved slot 28. The base plate 12 includes a pivot hole 30 at the midpoint 32 of the protractor 26. The fence 14 is shown as a bar having a thickness less than or equal to the height of the bar. The fence 14 includes a pivot hole 34 through the top 36 and bottom 38 of the fence 14, near the rear 40 of the fence 14. FIGS. 4, 6, 10 shows a round bearing surface 42 above the fence 14 and about the pivot hole 34 of the fence 14, which fits into the pivot hole 30 of the base plate 12. A pivot pin 44 is inserted into the pivot holes 30, 34 of the base plate 12 and fence 14 to rotatably attach the fence 14 to the base plate 12. The pivot pin 44 is secured in the pivot holes 30, 34 and can be as simple as a nut and bolt. The fence 14 includes a lock through hole 46 to receive a fence lock bolt 48. The lock through hole 46 of the fence 14 is aligned with the open curved slot 28 of the protractor 26. The fence lock bolt 48 is inserted up into the fence 14 and extends through the open curved slot 28. A tightening end 50 threads down onto the fence lock bolt 48 and against the top 20 of the base plate 12 to lock the fence 14 in position along the open curved slot 28. The tightening end 50 can be a nut or a knob. The fence 14 includes a line 52 scribed down the middle of the top 36 of the fence 14, as an indicator along the protractor 26 on the base plate 12. The line 52 to indicates the angle of the fence 14 to the cutting side 24 of the base plate 12, as shown in FIG. 5. FIGS. 5-6, 11 shows the base plate 12 including a curved groove 54 on the bottom 22 of the base plate 12. The curved groove 54 parallels the curved slot 28 of the protractor 26. FIGS. 5-6, 10-12 show the fence 14 including a groove stud 56 extending up from the top 36 of the fence 14. The groove stud 56 is positioned on the fence 15 such that the groove stud 56 engages and rides in the curved groove 54 of the base plate 12, for additional stability during movement between the fence 14 and the base plate 12. FIGS. 5-6, 8, 10-11 show a slot stud 58 as a second stud extending up from the fence 14. The slot stud 58 is positioned on the fence 14 such that the slot stud 58 engages and rides in the curved slot 28 of the base plate 12, for additional stability during movement between the fence 14 and the base plate 12. The groove stud 56 and the slot stud 58 can either or both act as a stop to align the fence 14 ninety-degrees to the cutting side 24 of the base plate 12 by ending the curved groove 54 and/or curved slot 28 properly.

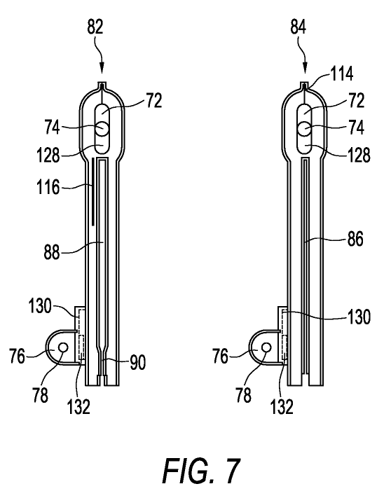

The blade guide 18 is pivotally connected to the base plate 12. The blade guide 18 includes a top 60, bottom 62, two sides 64 and two ends 68. The ends 68 are open and lead to a blade slot 70 in between the sides 64. The top 60 is closed and includes a channel 72 for a bolt 74 above the blade slot 70. The bottom 62 is open and allows the saw blade to slide down the blade slot 70 and into the material during cutting of the material. The blade guide 18 includes two pivot legs 76 extending outward from one of the sides 64 of the blade guide 18. The two pivot legs 76 of the blade guide 18 each include with holes 78. The pivot legs 76 are near each end 68 and near the bottom 62 of the blade guide 18. The pivot legs 76 of the blade guide 18 are on the same side of the blade guide 18. The base plate 12 includes two pivot legs 76 extending upward from the top 20 of the base plate 18 and along the cutting side 24 of the base plate 12. The two pivot legs 76 of the base plate 12 each include with holes 78. The pivot legs 76 of the base plate 12 are positioned such that the holes 78 of the pivot legs 76 of the base plate 12 can be aligned with the holes 78 of the pivot legs 76 of the blade guide 18. The blade guide 18 is rotatably attached to the base plate 12 by aligning the holes 78 of the pivot legs 76 of the base plate 12 and blade guide 18 and inserting a fastener 80 into the holes 78 at each set of base plate-blade guide pivot legs 76. The blade guide 18 is positioned such that the saw blade in the blade slot 70 clears the cutting side 24 of the base plate 12. FIG. 7 shows two different blade guides 82, 84 each having a different size blade slot. Blade slot 86 is for saws of a normal thickness. Blade slot 88 is for miter saws with a thicker top, whereby the blade slot 88 is thicker in width, except at the bottom 90 of the blade slot 88. The thinner width of the blade slot 88 at the bottom 90 is for proper positioning of the thinner cutting section of the blade of the miter saw.

There is at least one side rail 16 attached between the base plate 12 and the blade guide 18. Two side rails 16 are show in FIGS. 1-14, as this provides a stiffer blade guide 18, while cutting with a saw. The side rails 16 have a top 94 and a bottom 96 and are curved with a protractor 98 inscribed on a face between the top 94 and bottom 96. The bottom 96 of each side rail 16 is attached to the base plate 12. FIGS. 5-6, 10-11 show a raised lock tab 100 with a bolt hole 102 on the base plate 12 and a cavity 104 in the bottom 96 of each side rail 16. The cavity 104 is shaped to receive the lock tab 100, which provides positive positioning of the bottom 96 of each side rail 16 on the base plate 12. A bolt 106 is inserted from the bottom 22 of the base plate 12 into the bolt holes 102 of the lock tabs 100 and then the bolt 106 is threaded into a threaded hole beyond the cavity 104 and within the bottom 96 of each side rail 16. Other know methods of fastening can be employed to attach the bottom 96 of the side rails 16 to the base plate 12. The side rails 16 each include a curved slot 108 along the inscribed protractor 98. The bolt 74 which passes through the channel 72 of the blade guide 18 is first inserted through the curved slot 108 of the first side rail 16, into the channel 72 and on through the curved slot 108 of the second side rail 16. A tightening end 110, such as a nut or knob, threads onto a threaded end of the bolt 74. The blade guide 18 can be rotated about the pivot legs 76 on the base plate 12. The bolt 74 of the blade guide 18 moves along the curved slots 108 of the side rails 16 during rotation of the blade guide 18. When the blade guide 18 is at the proper angle, the tightening end 110 is tighten to secure the blade guide 18 along the side rails 16. As shown in FIGS. 1-3, a pointer 112 aligned with the blade slot 70 can be affixed to indicate degree of angle. As shown in FIG. 7, two types of indicator lines 114, 116 can be affixed to indicate degree of angle. Indicator line 114 is aligned with the blade slot 70 to indicate the degree of angle. Indicator line 116 is positioned on the blade guide 18 off position from the blade slot 70 and would require an offset protractor scale to correspond to the positioning of the indicator line 116 in relation to the blade slot 70.

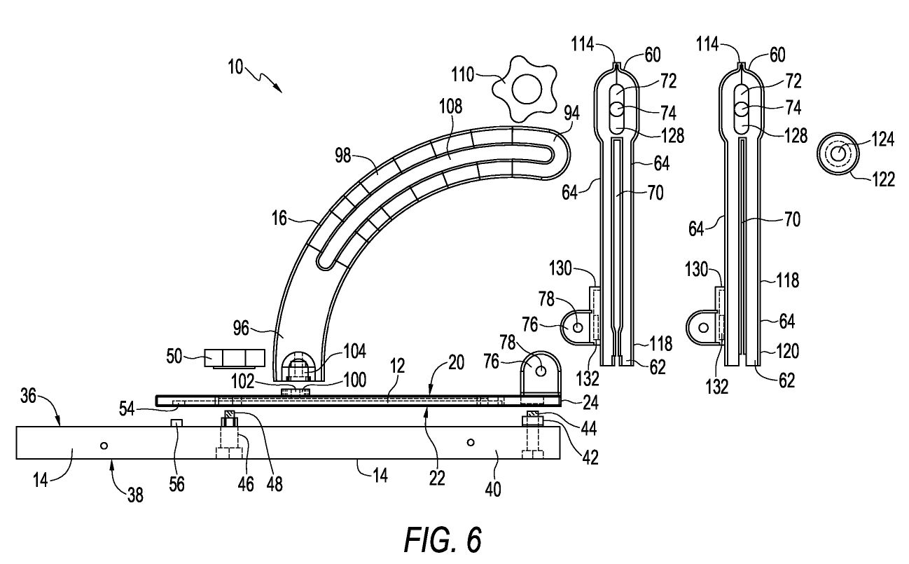

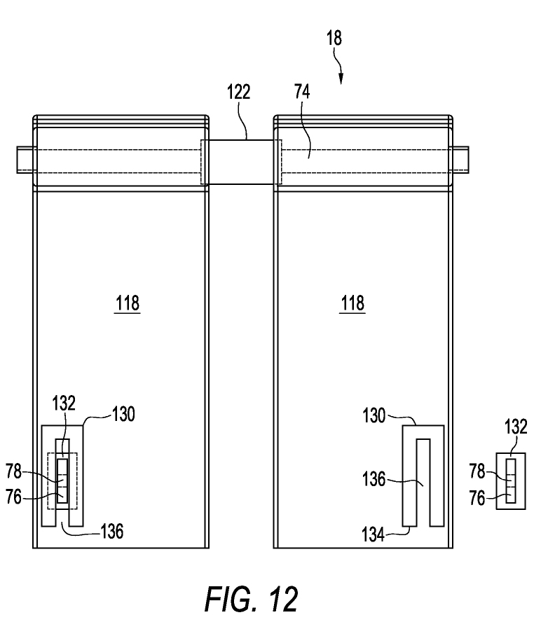

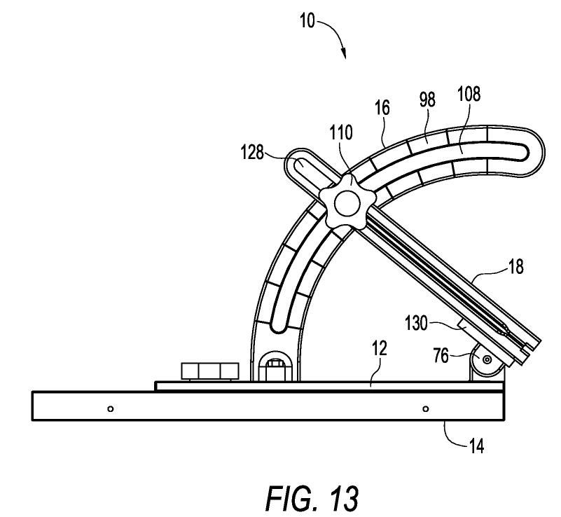

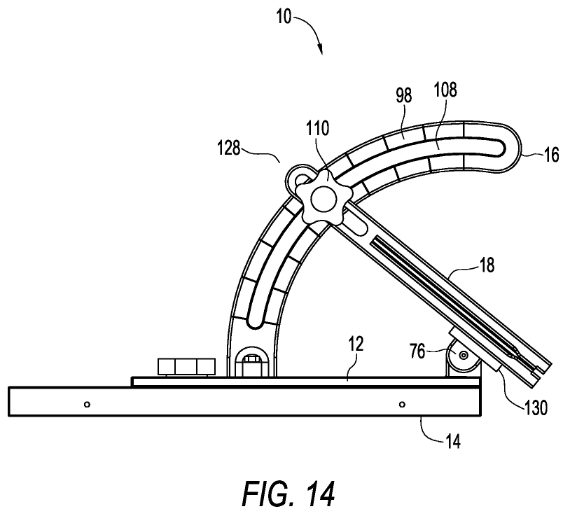

FIGS. 5-6, 8, 11 show a blade guide 18 with two outside sections 118 and a removable center section 120. FIGS. 6, 9-10, 12 show a spacer 122 used with the blade guide 18. The two outside sections 118 include the blade slot 88 for a miter saw with a thicker top section. The removable center section 120 includes the blade slot 86 for the normal size saw. The spacer 122 is a cylinder with a through hole 124. The spacer 122 is used between the outside sections 118 where the bolt 74 passes through the channel 72 of the blade guide 18. The spacer 122 is used when using a miter saw and the removable center section 120 is used when using a normal size saw. FIGS. 5-6, 11 show an additional pivot leg 76 extending from the removable center section 120 and two additional pivot legs 76 on the base plate 12. Each additional pivot leg 76 has a hole 78. The pivot leg 76 of the removable center section 120 fits between the two additional pivot legs 76 on the base plate 12. A fastener 80 is used to rotatably link the pivot legs 76 using holes 78. FIGS. 5-6, 11 also show two pivot legs 78 on the base plate 12 for each pivot leg 76 of the blade guide 18. FIGS. 6-7, 12-14 show a sliding version of the blade guide 18 which slides up and down, while maintaining the indicated angle shown along the protractor 98 of the side rails 16. The channel 72 in the top 60 of the sliding version of the blade guide 18, as shown in FIG. 6, is a slot 128 which allows the blade guide 18 to move up and down along the bolt 74 of the blade guide 18. The pivot legs 76 on the sliding version of the blade guide 18 are mounted in a slotted retainer 130 extending from the side 64 of the blade guide 18, as shown in FIG. 12. The pivot legs 76 include a back 132 which slides into an open bottom 134 of the slotted retainer 130. The slotted retainer 130 includes a slot 136 to allow the pivot leg 76 to extend out from the sliding version of the blade guide 18. When the pivot legs 76 of the sliding version of the blade guide 18 are attached to the pivot legs 76 of the base plate 12, the blade guide 18 can slide up and down the back 132 of the pivot legs 76 of the sliding version of the blade guide 18. FIGS. 13 and 14 show the sliding movement of the sliding version of the blade guide 18. FIGS. 5, 9-11 show a blade guide stud 138 on each end 68 of the blade guide 18 at the top 60 of the blade guide 18. The blade guide stud 138 provides stability when rotating the blade guide 18 about the base plate 12.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

1. A compound miter guide comprising:
a base plate, said base plate including a top, bottom, cutting side, protractor inscribed on said top, a curved slot in said base plate along said protractor, and a midpoint of said protractor;
a fence pivotally attached to said bottom of said base plate at said midpoint;
a base plate fastener; said base plate fastener used to movably connect said fence to said base plate along said curved slot, said fastener including a tightening end to secure said fence along said base plate;
a blade guide pivotally attached to said base plate at said cutting side of said base plate using a pivotal connection, said blade guide including a top, open bottom, two sides, two open ends, a blade slot between said sides, open bottom and said open ends;
at least one side rail having a top and bottom and being attached between said base plate and said blade guide, said bottom of said at least one side rail attached to said base plate, and said top of said at least one side rail attached to said blade guide such that said blade guide is movable along said at least one side rail at least one protractor inscribed between said top and said bottom on one of said at least one side rail.

2. The compound miter guide of claim 1, wherein said top of said at least one side rail is attached above said blade slot at said top of said blade guide.

3. The compound miter guide of claim 2, further including at least one fastener; wherein said at least one side rail includes a protractor slot; wherein said at least one fastener is used to movably connect said top of said blade guide to said protractor slot of said at least one side rail; and wherein said fastener includes a tightening end to secure said blade guide along said protractor slot of said at least one side rail.

4. The compound miter guide of claim 1, wherein there are two side rails and said ends of said blade guide are between said two side rails.

5. The compound miter guide of claim 4, wherein said top of said side rails are attached above said blade guide at said top of said blade guide.

6. The compound miter guide of claim 5, further including at least one fastener; wherein said side rails include a protractor slot; wherein at least one of said two side rails includes a protractor inscribed; wherein said at least one fastener is used to movably connect said top of said blade guide between said protractor slots of said two side rails; and wherein said fastener includes a tightening end to secure said blade guide along said protractor slots of said two side rails.

7. The compound miter guide of claim 3, wherein said top of said blade guide includes a channel to receive a bolt as said fastener.

8. The compound miter guide of claim 6, wherein said top of said blade guide includes a channel to receive a bolt as said fastener.

9. The compound miter guide of claim 1, further including a curved groove on said bottom of said base plate; further including a fence stud extending up from a top of said fence; and wherein said fence stud is positioned to engage said curved groove.

10. The compound miter guide of claim 1, wherein said blade slot is enlarged at an upper portion to receive a miter saw with a thicker top.

11. The compound miter guide of claim 1, wherein said blade guide includes a removable center section having a thinner blade slot for guiding thinner saw blades, which can be remove to allow use of thicker saw blades.

12. The compound miter guide of claim 1, wherein said blade guide is slidable at said pivotal connection and at a connection between said at least one side rail and said blade guide to allow said blade guide to slidably move along a line formed by said blade slot.

13. The compound miter guide of claim 12, wherein pivotal connection is a base plate pivot leg, a blade guide pivot leg and a slotted retainer on said blade guide; wherein said base plate pivot leg and said blade guide pivot leg each have a hole to allow pivotal connection between said base plate pivot leg and said blade guide pivot leg; wherein said blade guide pivot leg includes a leg and a back; and wherein said slotted retainer includes a channel to slidably receive said back of said blade guide pivot leg and a slot to slidably receive said leg of said blade guide pivot leg.

14. The compound miter guide of claim 1, wherein said top of said at least one side rail is attached above said blade slot at said top of said blade guide; further including at least one fastener; wherein said at least one side rail includes a protractor slot; wherein said at least one fastener is used to movably connect said top of said blade guide to said protractor slot of said at least one side rail; wherein said fastener includes a tightening end to secure said blade guide along said protractor slot of said at least one side rail; further including a curved groove on said bottom of said base plate; further including a fence stud extending up from a top of said fence; and wherein said fence stud is positioned to engage said curved groove.

15. The compound miter guide of claim 1, wherein there are two side rails and said ends of said blade guide are between said two side rails; wherein said top of said side rails are attached above said blade guide at said top of said blade guide; further including at least one fastener; wherein said side rails include a protractor slot; wherein at least one of said two side rails includes a protractor inscribed; wherein said at least one fastener is used to movably connect said top of said blade guide between said protractor slots of said two side rails; wherein said fastener includes a tightening end to secure said blade guide along said protractor slots of said two side rails; further including a curved groove on said bottom of said base plate; further including a fence stud extending up from a top of said fence; and wherein said fence stud is positioned to engage said curved groove.

16. The compound miter guide of claim 1, wherein said top of said at least one side rail is attached above said blade slot at said top of said blade guide; further including at least one fastener; wherein said at least one side rail includes a protractor slot; wherein said at least one fastener is used to movably connect said top of said blade guide to said protractor slot of said at least one side rail; wherein said fastener includes a tightening end to secure said blade guide along said protractor slot of said at least one side rail; and wherein said blade slot is enlarged at an upper portion to receive a miter saw with a thicker top.

17. The compound miter guide of claim 1, wherein there are two side rails and said ends of said blade guide are between said two side rails; wherein said top of said side rails are attached above said blade guide at said top of said blade guide; further including at least one fastener; wherein said side rails include a protractor slot; wherein at least one of said two side rails includes a protractor inscribed; wherein said at least one fastener is used to movably connect said top of said blade guide between said protractor slots of said two side rails; wherein said fastener includes a tightening end to secure said blade guide along said protractor slots of said two side rails; and wherein said blade slot is enlarged at an upper portion to receive a miter saw with a thicker top.

18. The compound miter guide of claim 1, wherein said top of said at least one side rail is attached above said blade slot at said top of said blade guide; further including at least one fastener; wherein said at least one side rail includes a protractor slot; wherein said at least one fastener is used to movably connect said top of said blade guide to said protractor slot of said at least one side rail; wherein said fastener includes a tightening end to secure said blade guide along said protractor slot of said at least one side rail; and wherein said blade guide includes a removable center section having a thinner blade slot for guiding thinner saw blades, which can be remove to allow use of thicker saw blades.

19. The compound miter guide of claim 1, wherein there are two side rails and said ends of said blade guide are between said two side rails; wherein said top of said side rails are attached above said blade guide at said top of said blade guide; further including at least one fastener; wherein said side rails include a protractor slot; wherein at least one of said two side rails includes a protractor inscribed; wherein said at least one fastener is used to movably connect said top of said blade guide between said protractor slots of said two side rails; wherein said fastener includes a tightening end to secure said blade guide along said protractor slots of said two side rails; and wherein said blade guide includes a removable center section having a thinner blade slot for guiding thinner saw blades, which can be remove to allow use of thicker saw blades.

20. The compound miter guide of claim 1, wherein said top of said at least one side rail is attached above said blade slot at said top of said blade guide; further including at least one fastener; wherein said at least one side rail includes a protractor slot; wherein said at least one fastener is used to movably connect said top of said blade guide to said protractor slot of said at least one side rail; wherein said fastener includes a tightening end to secure said blade guide along said protractor slot of said at least one side rail; and wherein said blade guide is slidable at said pivotal connection and at a connection between said at least one side rail and said blade guide to allow said blade guide to slidably move along a line formed by said blade slot.

21. The compound miter guide of claim 1, wherein there are two side rails and said ends of said blade guide are between said two side rails; wherein said top of said side rails are attached above said blade guide at said top of said blade guide; further including at least one fastener; wherein said side rails include a protractor slot; wherein at least one of said two side rails includes a protractor inscribed; wherein said at least one fastener is used to movably connect said top of said blade guide between said protractor slots of said two side rails; wherein said fastener includes a tightening end to secure said blade guide along said protractor slots of said two side rails; and wherein said blade guide is slidable at said pivotal connection and at a connection between said at two side rails and said blade guide to allow said blade guide to slidably move along a line formed by said blade slot.

22. The compound miter guide of claim 20, wherein pivotal connection is at least one base plate pivot leg, at least one blade guide pivot leg and at least one slotted retainer on said blade guide; wherein said base plate pivot leg and said blade guide pivot leg each have a hole to allow pivotal connection between said base plate pivot leg and said blade guide pivot leg; wherein said blade guide pivot leg includes a leg and a back; and wherein said slotted retainer includes a channel to slidably receive said back of said blade guide pivot leg and a slot to slidably receive said leg of said blade guide pivot leg.

23. The compound miter guide of claim 21, wherein pivotal connection is at lease one base plate pivot leg, at least one blade guide pivot leg and at least one slotted retainer on said blade guide; wherein said base plate pivot leg and said blade guide pivot leg each have a hole to allow pivotal connection between said base plate pivot leg and said blade guide pivot leg; wherein said blade guide pivot leg includes a leg and a back; and wherein said slotted retainer includes a channel to slidably receive said back of said blade guide pivot leg and a slot to slidably receive said leg of said blade guide pivot leg.

24. The compound miter guide of claim 12, wherein said top of said blade guide includes a channel to receive a bolt as said fastener; where said channel is a slot to allow said blade guide to move along said bolt to allow movement along said line formed by said blade slot.

25. The compound miter guide of claim 13, wherein said top of said blade guide includes a channel to receive a bolt as said fastener; where said channel is a slot to allow said blade guide to move along said bolt to allow movement along said line formed by said blade slot.

26. The compound miter guide of claim 20, wherein said top of said blade guide includes a channel to receive a bolt as said fastener; where said channel is a slot to allow said blade guide to move along said bolt to allow movement along said line formed by said blade slot.

27. The compound miter guide of claim 21, wherein said top of said blade guide includes a channel to receive a bolt as said fastener; where said channel is a slot to allow said blade guide to move along said bolt to allow movement along said line formed by said blade slot.

28. The compound miter guide of claim 22, wherein said top of said blade guide includes a channel to receive a bolt as said fastener; where said channel is a slot to allow said blade guide to move along said bolt to allow movement along said line formed by said blade slot.

29. The compound miter guide of claim 23, wherein said top of said blade guide includes a channel to receive a bolt as said fastener; where said channel is a slot to allow said blade guide to move along said bolt to allow movement along said line formed by said blade slot.

30. A compound miter guide comprising:
a base plate, said base plate including a top, bottom, cutting side, protractor inscribed on said top;
a fence attached to said bottom of said base plate at said midpoint;
a blade guide pivotally attached to said base plate at said cutting side of said base plate using a pivotal connection, said blade guide including a top, open bottom, two sides, two open ends, a blade slot between said sides, open bottom and said open ends; and
at least one side rail having a top and bottom and being attached between said base plate and said blade guide, said bottom of said at least one side rail attached to said base plate, and said top of said at least one side rail attached to said blade guide such that said blade guide is movable along said at least one side rail.

31. The compound miter guide of claim 30, wherein at least one protractor is inscribed between said top and said bottom on one of said at least one side rail.

32. The compound miter guide of claim 30, wherein said blade slot is enlarged at an upper portion to receive a miter saw with a thicker top.

33. The compound miter guide of claim 30, wherein said blade guide includes a removable center section having a thinner blade slot for guiding thinner saw blades, which can be remove to allow use of thicker saw blades.

34. The compound miter guide of claim 30, wherein said blade guide is slidable at said pivotal connection and at a connection between said at least one side rail and said blade guide to allow said blade guide to slidably move along a line formed by said blade slot.

35. The compound miter guide of claim 34, wherein pivotal connection is a base plate pivot leg, a blade guide pivot leg and a slotted retainer on said blade guide;
wherein said base plate pivot leg and said blade guide pivot leg each have a hole to allow pivotal connection between said base plate pivot leg and said blade guide pivot leg; wherein said blade guide pivot leg includes a leg and a back; and wherein said slotted retainer includes a channel to slidably receive said back of said blade guide pivot leg and a slot to slidably receive said leg of said blade guide pivot leg.
